(19) United States
(12) Patent Application Publication
(10) Pub. No.: US 2016/0086025 A1
(43) Pub. Date: Mar. 24, 2016

(54) POSE TRACKER WITH MULTI THREADED ARCHITECTURE

(71) Applicant: Microsoft Corporation, Redmond, WA (US)

(72) Inventors: Jamie Daniel Joseph Shotton, Cambridge (GB); Toby Sharp, Cambridge (GB); Duncan Paul Robertson, Cambridge (GB); Andrew William Fitzgibbon, Cambridge (GB)

(21) Appl. No.: 14/494,385

(22) Filed: Sep. 23, 2014

(51) Int. Cl. G06K 9/00; G06T 7/20; G06T 7/00

(52) U.S. Cl. CPC G06K 9/00369; G06K 9/00335; G06K 9/00241; G06K 9/00375; G06K 9/00208; G06T 7/0046; G06T 7/2046; G06K 2209/21; G06K 2009/366

(57) ABSTRACT

Tracking pose of an articulated entity from image data is described, for example, to control a game system, natural user interface or for augmented reality. In various examples a plurality of threads execute on a parallel computing unit, each thread processing data from an individual frame of a plurality of frames of image data captured by an image capture device. In examples, each thread is computing an iterative optimization process whereby a pool of partially optimized candidate poses is being updated. In examples, one or more candidate poses from an individual thread are sent to one or more of the other threads and used to replace or add to candidate poses at the receiving thread(s).

### BACKGROUND

Tracking pose of articulated entities from image data, such as hand tracking or full body tracking has the potential to open up new human-computer interaction scenarios. However, the computational complexity involved is significant and there is an ongoing need to trade off accuracy against speed.

The embodiments described below are not limited to implementations which solve any or all of the disadvantages of known pose trackers.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Tracking pose of an articulated entity from image data is described, for example, to control a game system, natural user interface or for augmented reality. In various examples a plurality of threads execute on a parallel computing unit, each thread processing data from an individual frame of a plurality of frames of image data captured by an image capture device. In examples, each thread is computing an iterative optimization process whereby a pool of partially optimized candidate poses is being updated. In examples, one or more candidate poses from an individual thread are sent to one or more of the other threads and used to replace or add to candidate poses at the receiving thread(s).

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a pose tracker with a multi-threaded architecture used to track pose of a human hand;

FIG. 2 is a schematic diagram of a plurality of frames of image data and pools of partially optimized candidate pose solutions;

FIG. 3 is a flow diagram of a method at a source thread;

FIG. 4 is a flow diagram of a method at a destination thread;

FIG. 5 is a flow diagram of a method at a stochastic optimization process at a single thread;

FIG. 6 illustrates an exemplary computing-based device in which embodiments of a hand or body tracker may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

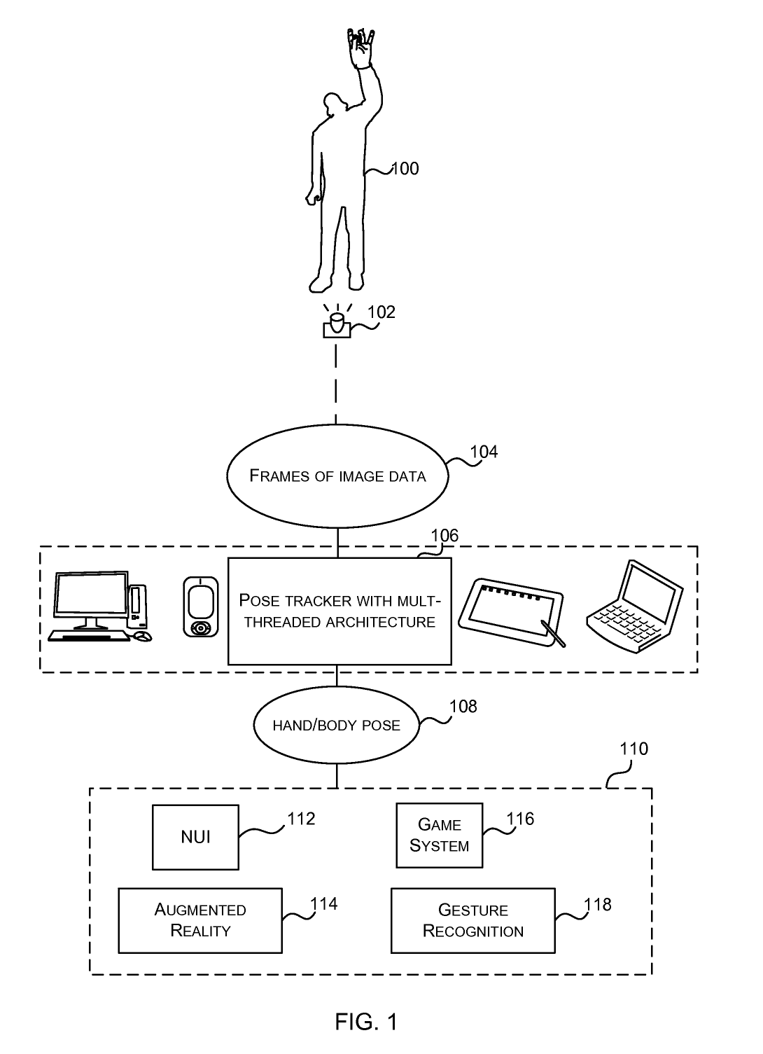

FIG. 1 is a schematic diagram of a pose tracker 106 with a multi-threaded architecture used to track pose of a human hand and/or of the full body of the user 100. The multi-threaded architecture described herein is particularly suited to high frame rate input such as 1000 Hz because many threads are able to run asynchronously on different input frames. However, the architecture is also operable for more standard frame rate input, such as 30 Hz or 60 Hz. The multi-threaded architecture facilitates a trade-off between latency and bandwidth. Latency is the delay between capturing/receiving a frame and calculating pose. Bandwidth is the frame rate of input image data that can be dealt with. In some examples, the multi-threaded architecture described herein also acts to reduce jitter in the tracked pose which may occur as a result of multi-threading.

A user 100 is standing and making hand or body gestures above an image capture device 102 which is on the floor. The image capture device sends frames of image data 104 to a computing device that incorporates a pose tracker 106 with a multi-threaded architecture. For example, the pose tracker may be in communication with a personal computer, a laptop computer, a game console, a mobile phone or a tablet computer. The pose tracker 106 with multi-threaded architecture may be located in the cloud or at any computing entity remote of the image capture device 102. In that situation, the image data may be compressed before sending it to the pose tracker using any well-known image compression technology. In some examples the pose tracker 106 is integrated, in whole or in part, with the image capture device 102.

The term “pose” is used here to refer to a global position and global orientation of an articulated entity such as a human hand, head, or body and also a plurality of joint angles of the articulated entity. For example, pose may comprise more than 10 or more than 20 degrees of freedom depending on the detail and complexity of a 3D model of the articulated entity used.

The pose tracker 106 takes as input one or more streams comprising frames of image data 104 from at least one capture device 102. The capture device 102 is able to capture one or more streams of images. For example, the capture device 102 comprises a depth camera of any suitable type such as time of flight, structured light, stereo, speckle decorrelation. In some examples the capture device 102 comprises a color (RGB) video camera in addition to, or in place of a depth camera. For example, data from a color video camera may be used to compute depth information. The frames of image data 104 input to the pose tracker 106 comprise frames of image data such as red, green and blue channel data for a color frame, depth values from a structured light sensor, three channels of phase data per frame from a time of flight sensor, a pair of stereo images per frame from a stereo camera, speckle images from a speckle decorrelation sensor. The frame rate of the input image data 104 may be high, such as 1000 Hz or more in some example. The frame rate of the input image data 104 may also be 30 Hz or 60 Hz. These are examples only.

The pose tracker 106 produces as output a stream of tracked pose values 108. The pose may be expressed as a vector (or other format) of values, one for each degree of freedom of the pose being tracked. For example, 10 or more, or 20 or more values. In one example, the pose vector comprises a global translation component, a global rotation component, and a joint transformation component. In an example, the pose vector comprises 3 degrees of freedom for a global rotation component, 3 degrees of freedom for a global translation component, and 4 degrees of freedom for each of a plurality of joint transformations). The joint transformations may be specified in a kinematic model of the hand which may or may not be anatomically valid.

The pose tracker 106 sends the tracked hand pose 108 to a downstream application or apparatus 110 such as a game system 116, an augmented reality system 114, a natural user interface 112, a gesture recognition system 118. These are examples only and other downstream applications or apparatus may be used. The downstream application or apparatus 110 is able to use the tracked pose 108 to control and/or update the downstream application or apparatus.

The pose tracker 106 executes a plurality of threads in parallel, for example using a parallel computing unit such as a graphics processing unit, a multi core processor or any other well-known parallel computing unit. An individual thread processes image data from an individual one of the frames.

The pose tracker 106 is arranged to compute the pose of the articulated entity from the frames of image data using an iterative optimization process whereby a pool of candidate poses is iteratively refined.

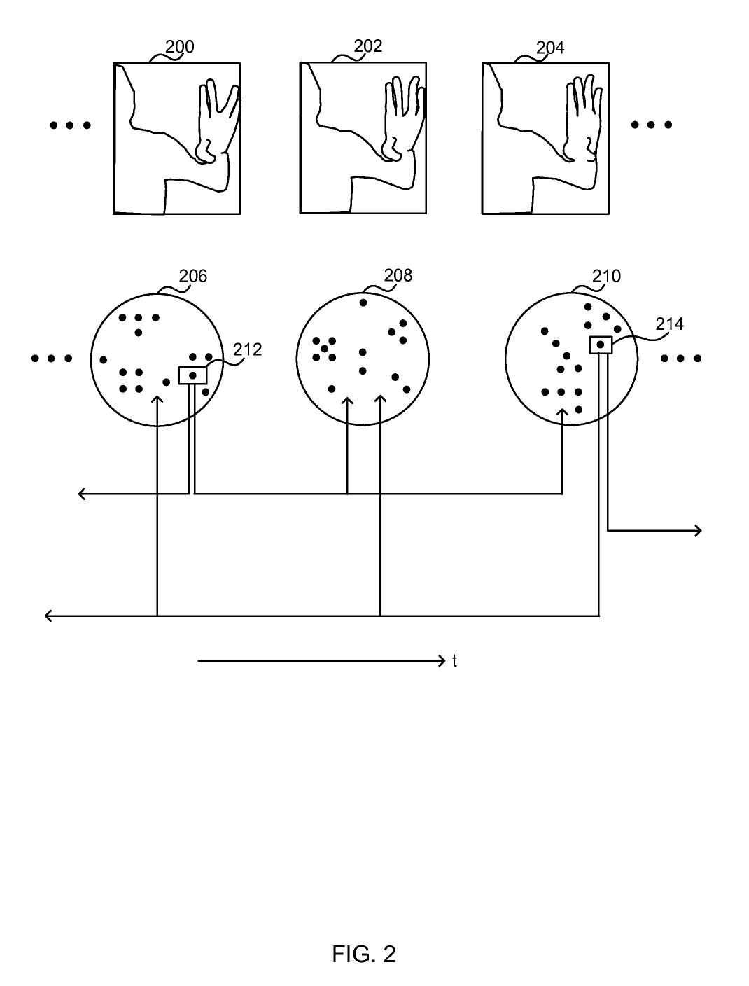

By sharing candidate solutions between threads improvements in speed of computation and/or accuracy of tracked pose are found. By sharing candidate solutions between threads a reduction in jitter or flicker in the tracked pose stream 108 is achieved. For example, it might take 100 msec to compute a pose from one frame by fully optimizing a stochastic optimization process, although it may take only 30 msec for a new frame to arrive. Therefore partial solutions obtained from ongoing iterative optimization process for an individual frame may be usefully shared with similar processes for other frames. This is now explained in more detail with reference to FIG. 2.

FIG. 2 shows part of a chronological sequence of frames of image data 200, 202, 204 with more recent frames towards the right hand side of the page. In this example the frames of image data 200, 202, 204 depict a user holding his hand to face the image capture device and moving his fingers together. Associated with each frame is a pool 206, 208, 210 of candidate pose solutions represented schematically using dots. For example, frame 200 is associated with a pool of candidate solutions 206 represented by dots inside a circle. Each pool 206, 208, 210 is of partially optimized pose solutions. That is, because each thread is part way through an ongoing optimization process, the end result of the optimization is not yet known at any of the threads.

At any one time, a current best solution is known at each of the threads. For example, at the current time associated with FIG. 2, the current best solution within candidate pool 206 is solution 212 and a current best solution within candidate pool 210 is solution 214.

The threads are arranged to share candidate solutions with one another. For example, the thread executing data from frame 200 selects a current best solution 212 and sends it to the other executing threads. This is illustrated in FIG. 2 by the arrows from solution 212 to the candidate pools 208 and 210 and by the arrow from solution 212 going backwards in time. That is, candidate solutions may be sent from a source thread to destination threads which are either in the future or historical with respect to the source thread. Another example in FIG. 2 is given by the arrow from solution 214 going backwards in time to pools 206 and 208 and also going forwards in time. The examples in FIG. 2 show single solutions being sent to other threads. However, it is also possible to send a plurality of solutions, such as the top n ranked solutions.

When a destination thread receives a candidate pose solution or solutions from another thread, it can either add the received candidate pose solution or solutions to its pool, or replace one of the existing members of the pool with the received candidate(s). A thread may select which one(s) of its candidate solutions to share with other threads on the basis of a quality score assigned to individual candidate solutions. The quality score is an indicator of how good the solution is. A thread may select which one(s) of its candidate solutions to replace by incoming received candidates from other threads, on the basis of the scores. For example, existing candidate solutions with poor scores may be replaced by incoming received candidates from other threads.

In some examples, when a thread receives a candidate solution from another thread, it propagates the candidate solution to make it appropriate for a timestamp of the frame of the current thread. The propagated candidate solution is added to the pool of candidate solutions after the propagation has been done. Propagation is useful where the pose of the articulated entity is changing between frames, as is often the case in many practical applications. For example, as indicated in FIG. 2 where the fingers of the hand move together. However, propagation is not essential and may be omitted. Propagation may take into account motion models of the articulated entity as described in more detail later in this document.

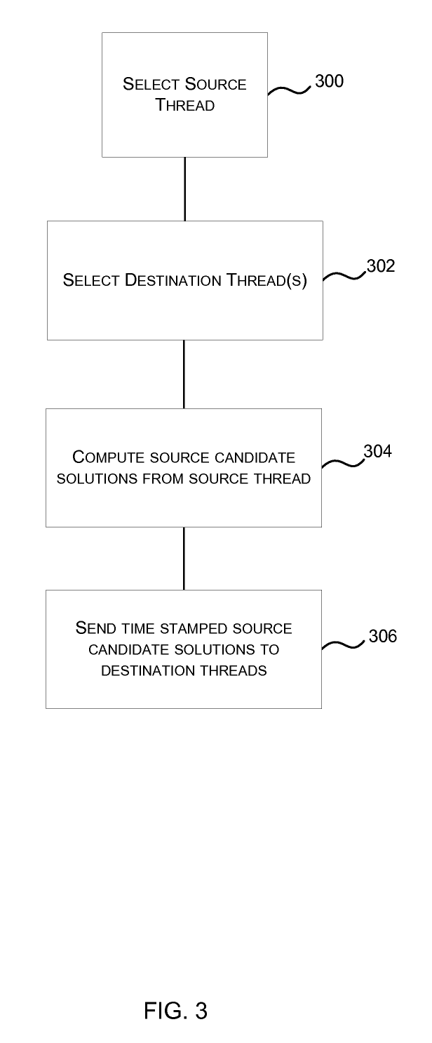

FIG. 3 is a flow diagram of a method at a source thread. A source thread is selected 300 to carry out this method. For example, this may be any thread which has an ongoing pose optimization process. In another example, it may be any thread which has an ongoing pose optimization process and (optionally) which is within a specified time window of the most recent frame.

The source thread selects 302 one or more destination threads. For example, this may be any other thread which has an ongoing optimization process. In another example, this may be any other thread which has an ongoing optimization process and which is within a specified time window of the source thread.

The source thread computes 304 one or more candidate solutions from its pool. For example, it selects the top n candidate solutions ranked by score, where the score is an indication of how good the candidate solution is.

The source thread optionally assigns a time stamp to the selected candidate solutions. The time stamp indicates the time of the frame associated with the source thread. The source thread sends 306 the selected candidate solutions (with time stamps if available) to the selected destination threads.

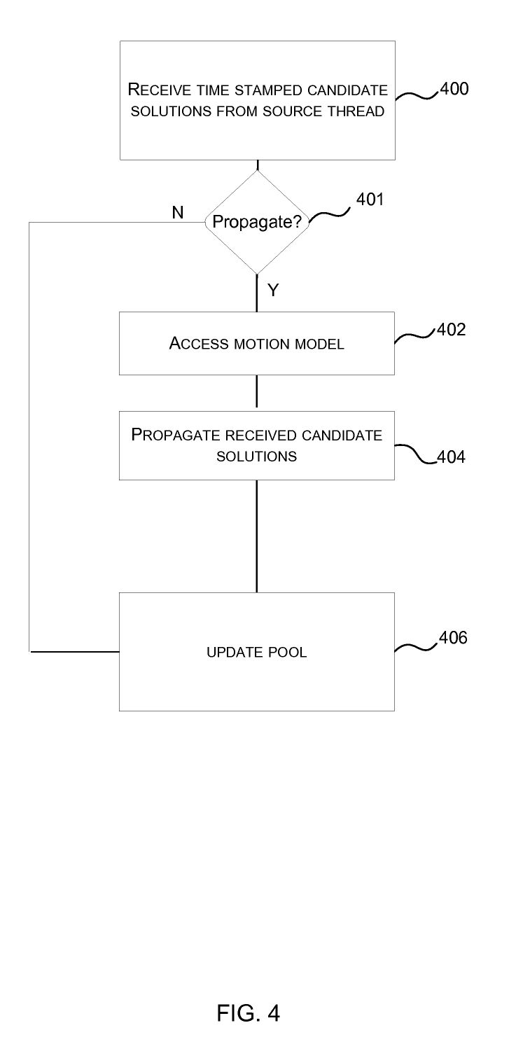

FIG. 4 is a flow diagram of a method at a destination thread. The destination thread receives 400 candidate solutions from a source thread. The received candidate solutions have time stamps in some examples. Where propagation is to be applied, a motion model is accessed 402 and used to propagate 404 the received candidate poses so that they are appropriate for the time stamp of the destination thread. For example, the motion model is a constant velocity model and linear interpolation or extrapolation is used to propagate the pose. In an example the translation and scale components of the pose are linearly interpolated, global rotation undergoes linear quaternion interpolation, and joint Euler angles are linearly interpolated. Other motion models may also be used such as constant acceleration or others.

In some examples propagation is not applied. For example, in high frame rate scenarios where the received candidate solution is more recent than the destination thread. The destination thread may decide 401 whether to apply propagation or not, on the basis of the time stamp of the received candidate solutions and/or using pre-configured data and rules about the frame rate.

The destination thread adds 406 the received candidate solution(s) (in raw form or in propagated form) to its pool, either by replacing one or more of the existing solutions in the pool or by increasing the number of solutions in the pool. In the case of replacement, the candidate solution(s) to be replaced are selected on the basis of scores as mentioned above. For example, the worst scoring candidates.

Note that a single thread may act as a source thread and as a destination thread at the same time. The methods of FIGS. 3 and 4 separately show the actions of a thread acting as a source thread and acting as a destination thread for clarity.

The iterative optimization process used by a thread may be a stochastic optimization process in some examples. A stochastic optimizer is an iterative process of searching for a solution to a problem, where the iterative processes uses randomly generated variables. The stochastic optimization process may be a particle swarm optimization, a genetic algorithm process, a hybrid of a particle swarm optimization and a genetic algorithm process, or any other stochastic optimization which iteratively refines a pool of candidate poses. A particle swarm optimization process is a way of searching for a solution to a problem by iteratively trying to improve a candidate solution in a way which takes into account other candidate solutions (particles in the swarm). A population of candidate solutions, referred to as particles, are moved around in the search-space according to mathematical formulae. Each particle's movement is influenced by its local best known position but, is also guided toward the best known positions in the search-space, which are updated as better positions are found by other particles. This is expected to move the swarm toward the best solutions. A genetic algorithm process is a way of searching for a solution to a problem by generating candidate solutions using inheritance, splicing, and other techniques inspired by evolution.

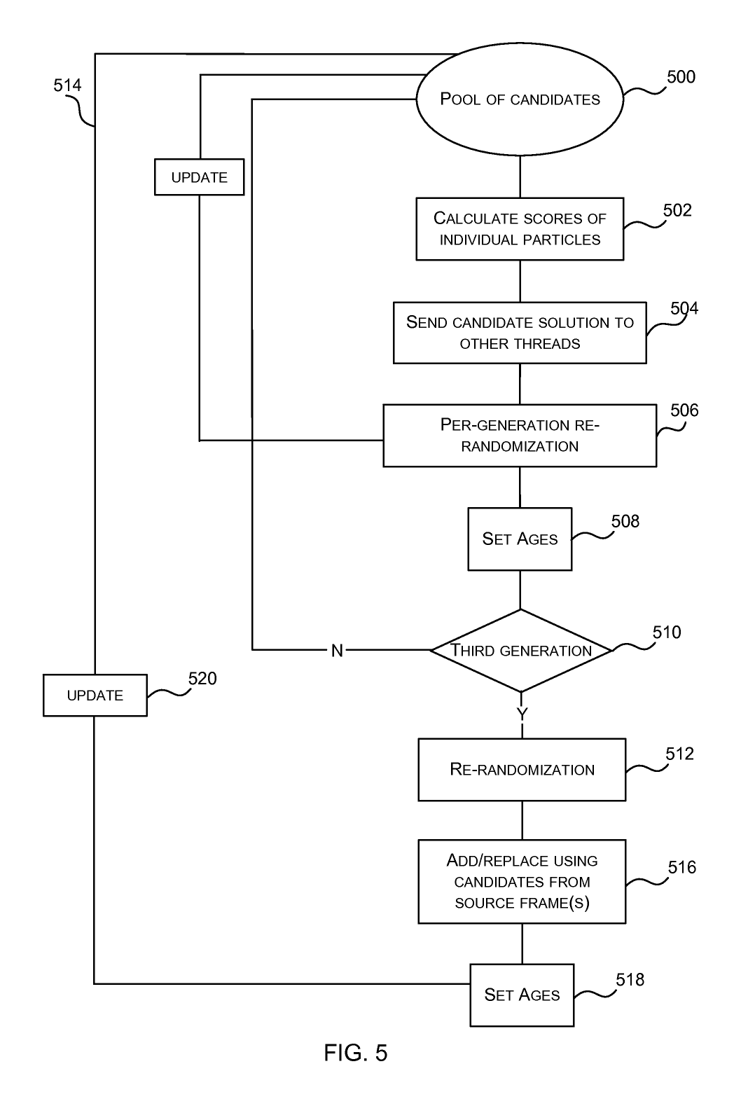

FIG. 5 is a flow diagram of an example method at a single thread in the case that a stochastic optimization process which is a hybrid of a particle swarm optimization and a genetic algorithm is executed. In this example the stochastic optimization uses splicing which is a type of genetic algorithm process. The stochastic optimization also uses candidate solutions in the pool to influence other candidate solutions in the pool, which is a type of particular swarm optimization process. However, these are examples only and other features of genetic algorithms and particle swarm processes may be combined in the hybrid.

The thread maintains a population of particles (the pool of candidate solutions 500) and a scoring function described below is evaluated on the population in parallel, yielding a score for each candidate solution. Each such evaluation comprises one generation. It is found experimentally that how the next generation is populated given the current particles has a big influence on performance of the process. The particular process of FIG. 5 is one example only and other types of stochastic optimization process may also be used.

At the start of the process the pool of candidate solutions 500 is initialized by taking the pose calculated from a previous frame and perturbing that pose to create candidate pose values. Initial candidate pose values may be selected at random but omitting poses which are impossible. In some examples, initial candidate pose values are calculated from a machine learning system which has been trained to predict correspondences between coordinates of scene points and coordinates of a 3D model of the articulated entity being tracked.

An example of a machine learning algorithm for predicting one or more full hand poses is now given. This example also applies to predicting body pose or pose of other objects or parts of objects; it is described with reference to hands for ease of understanding. A frame of image data 104 from the capture device 102 is input to a plurality of diverse predictors. The predictors have been trained to predict hand pose parameters which are complementary to one another, that is, which are diverse from one another. The predictions are dispersed over a space of possible predictions, but are still good predictions. For example the predictors are trained in series so that a trained predictor in the series may influence how later predictors in the series are trained. For example, a first predictor is trained using images of hands where the pose is is known. Training examples for which this predictor produces poor results are given greater weight that the examples in the rest of a training set, when used to train a second predictor in the series, and so on.

Predicted parameter values obtained at test time are used to select hand shapes from a library of hand shapes. These hand shapes are assessed by comparing them to the input images to find a hand shape which has a best fit to the input images. One of the hand shapes is selected and from this hand shape, pose of the hand depicted in the input image data is calculated.

The current pool of candidates 500 is accessed to calculate scores of the individual particles 502. One or more of the candidates is sent 504 to other threads using the process of FIG. 3.

In some examples, a per-generation re-randomization process 506 is carried out. This comprises adjusting the pose of 50% of the particles in a random manner (but omitting impossible poses) in the pool so that the pool is updated 514. The re-randomized particles may have their ages set 508 to a maximum age value. Note that the per-generation re-randomization process 506 is optional.

A check is made 510 for any particles which have reached the third generation, or other specified generation. Particles which have not reached their third generation remain in the pool of candidates and continue in the process. Particles which have reached their third generation enter a second re-randomization process 512. In the second re-randomization process a first portion of the particles are replaced by poses calculated by a machine learning system. For example, a machine learning system which has been trained to predict correspondences between coordinates of scene points and coordinates of a 3D model of the articulated entity being tracked. A second portion of the particles are subjected to local random perturbation. A third portion of the particles are subject to a splicing operation whereby a random particle is chosen from the top-ranked sub-set of the particles and the current particle overwrites, from the selected particle, a sub-set of the pose parameters. As a result the pool of candidates is updated 520. The re-randomized particles may have their ages set to zero.

As part of the second re-randomization 512, any candidate solutions received from other threads are added to or replaced 516 in the candidate pool.

In the situation where particles have ages and the ages are set as described above in step 508, the process of FIG. 5 treats all particles within a given age as an independent swarm. This treats candidate poses with different ages as being in different candidate pose pools. Accuracy is then improved by reducing interpolation across pose parameters including one or more of global rotation parameters, axis angle, Euler angle. However, it is not essential to take into account particle ages.

As mentioned above, the stochastic optimization process uses a scoring process. The scoring process may comprise rendering a synthetic image from a 3D model of the articulated entity being tracked. For example, a 3D model of a hand or a body. The synthetic depth image is compared with the observed image data to compute a score. The renderer make take into account occlusions. Other scoring processes may also be used such as approximating the 3D hand shape as a collection of spheres and comparing the surfaces of the spheres to the observed image data.

In the examples described above, an individual thread executes a search process to find a good candidate pose of an entity depicted in a single frame of observed image data, associated with the thread. However, in some examples, a single thread is able to take into account data from more than one frame of observed image data. For example, where the frame rate is higher than the rate at which the search process of an individual thread completes. Any of the examples described herein may be modified by replacing the frame of observed image data used to compute the score by a more recent frame of observed image data. This affects the quality score of the existing candidate solutions because the quality score comprises computing a comparison such as a distance metric between an observed image and the 3D model. The quality scores may be recomputed using a more recent frame. In this way, the final output of a thread is optimized towards a much more recent frame than would otherwise be the case. This helps to reduce latency of the pose tracker. Also, accuracy of the pose tracker is improved.

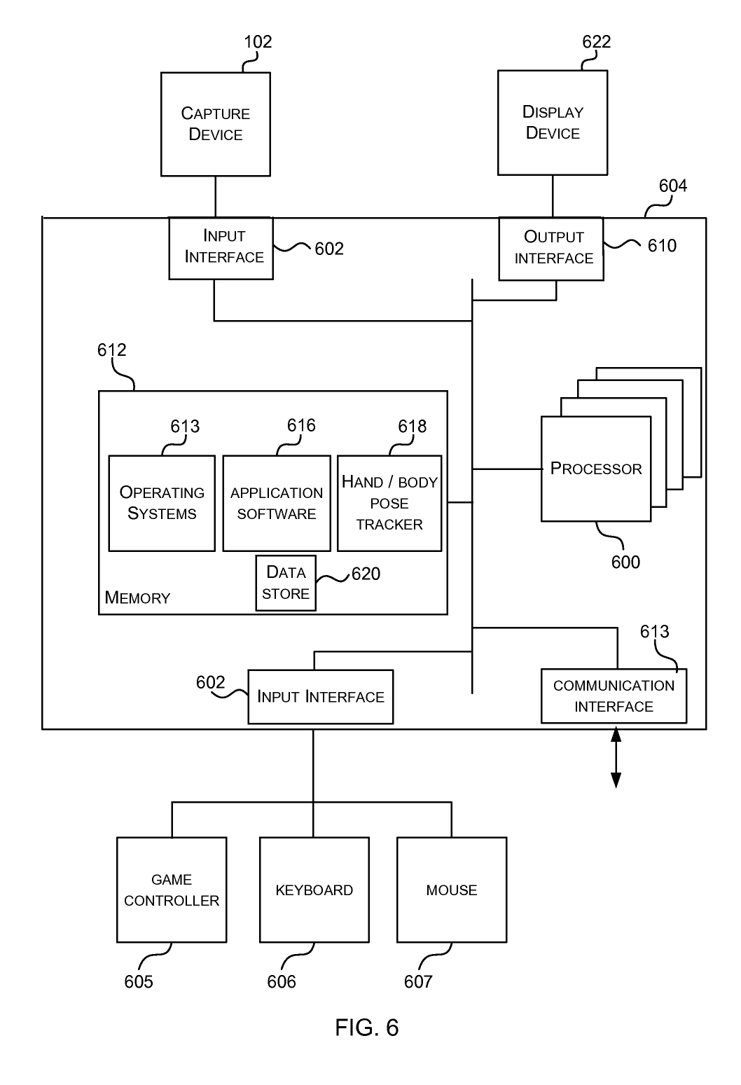

FIG. 6 illustrates various components of an exemplary computing-based device 604 which may be implemented as any form of a computing and/or electronic device, and in which embodiments of a pose tracker may be implemented. For example, a mobile phone, a tablet computer, a laptop computer, a personal computer, a web server, a cloud server.

Computing-based device 604 comprises one or more processors 600 which may be microprocessors, controllers or any other suitable type of processors for processing computer executable instructions to control the operation of the device in order to accurately track pose of hands or bodies in real time. In some examples, for example where a system on a chip architecture is used, the processors 600 may include one or more fixed function blocks (also referred to as accelerators) which implement a part of the method of any of FIGS. 2 to 5 in hardware (rather than software or firmware). The processors 600 comprise one or more parallel computing units such as a multi-core processor, graphics processing unit or other parallel computing unit. Platform software comprising an operating system 613 or any other suitable platform software may be provided at the computing-based device to enable application software 616 to be executed on the device. A data store 620 stores candidate poses, image data, tracked pose and/or other data. A pose tracker 618 comprises instructions to execute a part of the method of any of FIGS. 2 to 5.

The computer executable instructions may be provided using any computer-readable media that is accessible by computing based device 604. Computer-readable media may include, for example, computer storage media such as memory 612 and communications media. Computer storage media, such as memory 612, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 612) is shown within the computing-based device 604 it will be appreciated that the storage may be distributed or located remotely and accessed via a network or other communication link (e.g. using communication interface 613).

The computing-based device 604 also comprises an output interface 610 arranged to output display information to a display device 622 which may be separate from or integral to the computing-based device 604. For example, in the case of a tablet computer the display device 622 is integral with the computing-based device. The display information may provide a graphical user interface. An input interface 602 is also arranged to receive and process input from one or more devices, such as a user input device (e.g. a mouse 607, keyboard 606, game controller 605) and from the capture device 102 described above. In some examples the user input device may detect voice input, user gestures or other user actions and may provide a natural user interface (NUI). In an embodiment the display device 622 may also act as a user input device if it is a touch sensitive display device. The output interface 610 may also output data to devices other than the display device, e.g. a locally connected printing device.

Any of the input interface 602, output interface 610, display device 104 and the user input device may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

An example method of tracking pose of an articulated entity comprises:

receiving a stream of frames of image data depicting the articulated entity;

executing a plurality of threads in a parallel computing unit, each thread calculating a pool of partially optimized pose solutions from a different one of the frames of image data; and

sending from at least one of the threads, one or more selected ones of the pose solutions to at least one of the other threads.

By sending partially optimized pose solutions to other threads, accuracy and/or speed of computation is improved.

For example, the method comprises selecting the ones of the pose solutions to send to the other threads on the basis of a score indicating a quality of the pose solutions. the score being computed on the basis of a comparison between at least one frame of image data associated with a thread and a 3D model of the articulated entity.

For example the method comprises sending the selected pose solutions, from a source thread, to other threads being destination threads, which are historical with respect to the source thread.

For example the method comprises sending the selected pose solutions, from a source thread, to other threads being destination threads, which are in the future with respect to the source thread.

For example the method comprises sending the selected pose solutions from source thread to other threads being destination threads, and sending a time stamp of the source thread to the destination threads together with the selected pose solutions.

In examples the individual threads calculate the pool of partially optimized pose solutions using a stochastic optimization process.

In examples each thread is calculating the pool of partially optimized pose solutions using a hybrid of a particle swarm optimization and a genetic algorithm.

Examples comprise receiving, from another thread, a candidate pose solution and adding the candidate pose solution to the pool of partially optimized pose solutions.

Examples comprise receiving, from another thread, a candidate pose solution and replacing a partially optimized pose solution in the pool with the candidate pose solution.

Examples comprise receiving, from another thread, a candidate pose solution having a time stamp, and propagating the candidate pose solution on the basis of the time stamp and a motion model.

The example described in the previous paragraph may also be combined with propagating the candidate pose solution on the basis of a difference between the time stamp and a second time stamp being the time stamp of a frame associated with the pool of partially optimized pose solutions.

An example comprises selecting a partially optimized pose solution to be replaced on the basis of a quality score.

An example comprises re-computing the score, during the calculation of the partially optimized pose solutions, on the basis of a comparison between a more recent frame of image data and the 3D model of the articulated entity.

In examples there is a computer readable medium storing instructions which when executed by a computing device control the device to: receive a stream of frames of image data depicting an articulated entity;

execute a plurality of threads in a parallel computing unit, each thread iteratively optimizing a pool of pose solutions using a different one of the frames of image data;

sending between two or more of the threads, one or more selected ones of the pose solutions.

In an example, a pose tracker comprises:

an input interface arranged to receive a stream of frames of image data depicting an articulated entity;

a parallel computing unit executing a plurality of threads, each thread calculating a pool of partially optimized pose solutions from a different one of the frames of image data;

the parallel computing unit arranged to share between a plurality of the threads, one or more selected ones of the pose solutions.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of tracking pose of an articulated entity comprising:
receiving a stream of frames of image data depicting the articulated entity;
executing a plurality of threads in a parallel computing unit, each thread calculating a pool of partially optimized pose solutions from a different one of the frames of image data; and
sending from at least one of the threads, one or more selected ones of the pose solutions to at least one of the other threads.

2. The method as claimed in claim 1 comprising selecting the ones of the pose solutions to send to the other threads on the basis of a score indicating a quality of the pose solutions, the score being computed on the basis of a comparison between at least one frame of image data associated with a thread and a 3D model of the articulated entity.

3. The method as claimed in claim 1 comprising sending the selected pose solutions, from a source thread, to other threads being destination threads, which are historical with respect to the source thread.

4. The method as claimed in claim 1 comprising sending the selected pose solutions, from a source thread, to other threads being destination threads, which are in the future with respect to the source thread.

5. The method as claimed in claim 1 comprising sending the selected pose solutions from source thread to other threads being destination threads, and sending a time stamp of the source thread to the destination threads together with the selected pose solutions.

6. The method as claimed in claim 1 wherein individual threads calculate the pool of partially optimized pose solutions using a stochastic optimization process.

7. The method as claimed in claim 1 wherein each thread is calculating the pool of partially optimized pose solutions using a hybrid of a particle swarm optimization and a genetic algorithm.

8. The method as claimed in claim 1 comprising receiving, from another thread, a candidate pose solution and adding the candidate pose solution to the pool of partially optimized pose solutions.

9. The method as claimed in claim 1 comprising receiving, from another thread, a candidate pose solution and replacing a partially optimized pose solution in the pool with the candidate pose solution.

10. The method as claimed in claim 9 comprising selecting a partially optimized pose solution to be replaced on the basis of a quality score.

11. The method as claimed in claim 2 comprising re-computing the score, during the calculation of the partially optimized pose solutions, on the basis of a comparison between a more recent frame of image data and the 3D model of the articulated entity.

12. The method as claimed in claim 1 comprising receiving, from another thread, a candidate pose solution having a time stamp, and propagating the candidate pose solution on the basis of the time stamp and a motion model.

13. The method as claimed in claim 12 comprising propagating the candidate pose solution on the basis of a difference between the time stamp and a second time stamp being the time stamp of a frame associated with the pool of partially optimized pose solutions.

14. A computer readable medium storing instructions which when executed by a computing device control the device to:
receive a stream of frames of image data depicting an articulated entity;
execute a plurality of threads in a parallel computing unit, each thread iteratively optimizing a pool of pose solutions using a different one of the frames of image data; and
send between two or more of the threads, one or more selected ones of the pose solutions.

15. The computer readable medium of claim 14 storing instructions which when executed by a computing device control the device to selecting the ones of the pose solutions to send on the basis of a score indicating a quality of the pose solutions.

16. The computer readable medium of claim 14 storing instructions which when executed by a computing device control the device to send the selected ones of the pose solutions together with timestamps.

17. The computer readable medium of claim 14 storing instructions which when executed by a computing device control the device to execute the plurality of threads such that each thread executes a stochastic optimization process.

18. The computer readable medium of claim 14 storing instructions which when executed by a computing device control the device to execute the plurality of threads such that each thread executes a stochastic optimization process being a hybrid of a particle swarm optimization process and a genetic algorithm.

19. A pose tracker comprising:
an input interface arranged to receive a stream of frames of image data depicting an articulated entity; and
a parallel computing unit executing a plurality of threads, each thread calculating a pool of partially optimized pose solutions from a different one of the frames of image data;
the parallel computing unit arranged to share between a plurality of the threads, one or more selected ones of the pose solutions.

20. The pose tracker of claim 19 where the parallel computing unit is arranged to share the selected pose solutions between all the threads.
